(19) United States
(12) Patent Application Publication
(10) Pub. No.: US 2021/0083980 A1
(43) Pub. Date: Mar. 18, 2021

(54) Network Traffic Throughput Forecasting

(71) Applicants: Koninklijke KPN N.V., Rotterdam (NL); Nederlandse Organisatie Voor Toegepast-Natuurwetenschappelijk Onderzoek TNO, 's-Gravenhage (NL)

(72) Inventor: Robert Franciscus Maria Van Den Brink, The Hague (NL)

(21) Appl. No.: 16/954,413

(22) PCT Filed: Dec. 21, 2018
(86) PCT No.: PCT/EP2018/086480

§ 371 Date: Jun. 16, 2020

(30) Foreign Application Priority Data
Dec. 21, 2017 (EP) 17209233.0

(51) Int. Cl. H04L 12/801; H04L 12/825; H04L 12/26

(52) U.S. Cl. CPC H04L 47/127; H04L 43/0894; H04L 47/263

(57) ABSTRACT

A throughput forecaster (150) monitors data traffic in a network transferring data via a chain of network resources (101,102,106) between end nodes (110,120). A network resource in the chain generates performance data representing a performance level of the data traffic. An end node (110) executes a service application that establishes application data traffic via the chain. The forecaster (150) is arranged to obtain the performance data, and determines forecast data representing a throughput forecast for the chain based on the performance data, and communicates with the end node to provide the forecast data. The service application communicates with the forecaster to obtain the forecast data, and adapts the application data traffic based on the forecast data.

### FIELD OF THE INVENTION

The invention relates to a processor system for monitoring data traffic in a network. The invention further relates to an end node device, a network resource, a processing method, an application method and computer programs comprising instructions for causing a processor system to perform the methods.

The network has network resources including nodes and links connecting the nodes, and the network being configurable for transferring data via a chain of network resources between a first end node and a second end node enabling application data traffic. The end nodes have network interfaces for exchanging data via the network. For example, the chain may connect a server node and a client node as said end nodes, or two similar end nodes in a peer-to-peer setup. At least one end node may execute a service application requiring application data traffic, like internet radio, streaming of video content or video conferencing.

### BACKGROUND ART

Streaming of video content through the internet, also known as “over-the-top” (OTT), has become increasingly popular in the last decade, with services such as YouTube, Netflix and Hulu. Having to work over the best effort internet, current protocols for streaming OTT video, such as MPEG DASH (Dynamic Adaptive Streaming over HTTP, see ref [1]), are based on “adaptive bitrate streaming”, where the original video is offered in multiple versions, each characterized by a different video bitrate. Each video bitrate or version may correspond to a different video quality, and may require a different amount of bandwidth to be streamed to the user. Additionally, each version of the video stream may be temporally segmented into a sequence of segments or “chunks”, for easier transportation via the HTTP protocol. The video client may constantly estimate the available bandwidth (based for example on the speed at which the last few chunks have been downloaded) and that information may be used by the client to decide which version of the content should be retrieved. The client can also switch quality throughout the video stream to adjust to more or less bandwidth becoming available. These dynamic bandwidth adjustments, which make it possible to provide users with a continuous stream, have enabled OTT services to thrive.

Services like the above may require low-latency delivery of media content, especially when real-time video is involved. A good example are future Virtual Reality services, which may have more stringent requirements than current ones, and may be projected on a VR head mounted display, where the content is delivered by a local server or one in the cloud. Another example are video conferencing systems. So, for example, 5G requirements aim at end-to-end latency values as low as 1 msec.

A problem is that the quality of connectivity between nodes changes continuously over time. Changes may, for instance, be caused by physical disturbances of wired and/or wireless links, such as powerline modems, WiFi links, DSL lines (VDSL, G.Fast), and (5G) radio links. Network resources like modems have all kinds of mitigation techniques to cope with that. For example, modems may continuously adapt their bitrate to the actual level of physical disturbance (dynamic rate adaptation), or retransmit symbols or packets when forward error correction cannot recover from errors. And when throughput bandwidth is temporary too low, packets may be buffered for preventing packet loss and maintaining the throughput capacity on average. So, more latency may be introduced to resolve bandwidth problems.

Such disturbances are a fact of life, and time-critical streaming services may experience that expected video content does not arrive in time, and users will experience such events as images that keep hanging.

Some relief might be that when disturbances are temporary squeezing throughput bandwidth, clients may decide to reduce their bitrate demand, so that video frames can arrive in time, albeit at a lower video quality (using less bits). This approach may preserve latency at the cost of video quality, which may offer a better QoE (Quality of Experience).

### SUMMARY OF THE INVENTION

Prior art methods may enable clients, or more generally service applications, to reduce their bitrate demand, but the reduction comes after the problem has already occurred. So, unfortunately, known methods like those described in ref [1] (MPEG-DASH-5, SAND) are too slow. Hence there is a need for a system that enables adapting the application data traffic earlier.

In accordance with a first aspect of the invention, a processor system may be provided for monitoring data traffic in a network, the network comprising network resources including nodes and links connecting the nodes, and the network being configurable for transferring data via a chain of network resources enabling application data traffic between a first end node and a second end node;

wherein at least one of the network resources in the chain is arranged to generate performance data representing a performance level of the data traffic at the network resource and to exchange the performance data via the network;
wherein at least one end node of said end nodes is arranged to
execute a service application that establishes application data traffic via the chain,
communicate with the processor system to obtain forecast data, and
adapt the application data traffic based on the forecast data; and
   wherein the processor system comprises
   a communication interface for exchanging data via the network and
   a processor arranged to
obtain the performance data,
determine the forecast data representing a throughput forecast for the chain based on the performance data, and
communicate with the end node to provide the forecast data.

In accordance with a further aspect of the invention, an end node device is provided for adapting data traffic in the above network, wherein the end node device comprises a network interface for exchanging data via the network, and a processor arranged to
execute at least one service application that establishes application data traffic via the chain,
communicate with the processor system to obtain the forecast data, and
adapt the application data traffic based on the forecast data.

In accordance with a further aspect of the invention, a processing method is provided for monitoring data traffic in the above network, wherein the processing method comprises
obtaining the performance data,
determining the forecast data representing a throughput forecast for the chain based on the performance data, and
communicating with the end node to provide the forecast data.

In accordance with a further aspect of the invention, a service application method is provided for adapting data traffic in the above network, wherein the service application method comprises
establishing application data traffic via the chain,
communicating with the processor system to obtain the forecast data, and
adapting the application data traffic based on the forecast data.

In practice, the network may include one or more network parts like a home network, a company network, a network domain under control of a specific service provider, e.g. an internet service provider (ISP). Such a network may comprise a multitude of network resources including nodes and links connecting the nodes, and optionally network controllers having a network controller interface for exchanging network control data. The network controller may be arranged to control one or more network resources, e.g. program various settings and structures of links and nodes, which may be called software defined networking (SDN). The network controller may also be part of the Session Management Function (SMF) or Policy Control Function (PCF) envisioned in future 5G network architectures. Similarly, the network resources (links and nodes) may be part of one or more User Plane Functions (UPF). The proposed processor system may be part of an Application Function (AF), SMF or UPF, where AF, SMF and UPF are elements of proposed 5G network architectures. Furthermore, whilst the claims and the elucidation below may mention a first and a second end node, an end node device, a client, server, etcetera, in practice, there may be a multitude of each of these elements acting as end nodes coupled to the network.

The network may be configurable for transferring data via a chain of network resources between a first end node and a second end node, while the chain may enable application data traffic. Each end node may have a network interface and further control logic for exchanging data via the network, well-known as such. The first and second end nodes may be peers, e.g. a symmetric system like a video conferencing system, when the end nodes exchange video according to a peer-to-peer communication model. Also, the end nodes may be asymmetric, like in a client-server communication model the first end node being a server and the second end node being a client. In this document, each end node is executing at least one respective service application that embodies a respective functionality required at the end node.

In a practical example, one end node may be a server executing a service application where a stream of application data is provided to enter the network. The server may be coupled to a network resource like an edge node of the network domain, or some node inside the domain if the server is located in the network itself, or to a network forwarding element. The forwarding element may be part of an ISP network domain coupled to a server in a further network, for example at the edge of the network domain. The other end node may be a client where a service application uses the application data as received via the network. An end node device running a service application that receives a video stream may be called a video client or client node, e.g. a television or app at a mobile phone. A video client at the home of a consumer may be coupled to a home gateway via a Wi-Fi link, which gateway and link then constitute some of the network resources of a chain connecting the client to a server. Similarly, one or more mobile video clients may be coupled to a cell or base station via a radio link, which node and link also constitute network resources in the chain. A specific video stream may originate at an end node running a service application which provides a video stream, while such end node may be called a video server. The specific video stream ends at a respective client which consumes the video stream.

The sequence of network resources that are involved in transferring the application data between end nodes is called the chain which enables application data traffic. In the current context, the chain for transferring the application data traffic, e.g. a content stream originating at a server, starts at one end node coupled (directly or indirectly) to the network and terminates at a further end node coupled to the network, e.g. a node device executing a service application like a mobile phone or set top box. A chain may comprise multiple network resources like nodes and links connecting the nodes, which resources may, of course, be shared between multiple chains and other network users.

In accordance with a further aspect of the invention, an network resource is provided for enabling data traffic in the above network, the network resource comprising a resource network interface for exchanging the performance data via the network, and a resource processor arranged
to receive performance criteria,
to generate the performance data representing a performance level of the data traffic at the network resource with respect to the performance criteria, and
to provide the performance data via the network to the processor system. For example, the performance criteria may comprise a bitrate margin threshold and/or a noise level limit, while the network resource detects violation of the received criteria and subsequently generates a report including the respective actual performance data and/or an excess of the actual levels over said threshold or limit.

The processor system may be arranged for determining forecasting data representing a throughput forecast about the monitored data traffic, and for providing such throughput forecast data to one or more of the end nodes. Each respective end node that is running a service application that is arranged to receive and apply the throughput forecast data may communicate with the processor system according to a predefined communication protocol to set up the communication, while such an end node or service application may be called “forecast-aware”.

For determining the forecasting data, the processor system may be arranged to monitor data traffic in the network. The processor system has a communication interface for exchanging data via the network and a processor arranged to obtain the performance data from one or more of the network resources that are part of the chain. The processor further determines forecast data representing a throughput forecast for the chain based on the performance data, and communicates with the respective end node to provide the forecast data. In this document, the processing system for providing the forecast data may also be called a throughput forecaster.

In the forecast-aware end node device, the processor may be arranged to communicate with the throughput forecaster to obtain the forecast data. The end node device may execute one or more service applications, and may adapt the application data traffic based on the forecast data. Optionally, the end node device or a network resource may comprise the above processor system.

The measures in the various system elements as mentioned above may have the following effect. At least one of the network resources in the chain may be arranged to generate performance data. The performance data may represent a performance level of the data traffic at the network resource. A resource network interface may be provided for exchanging the performance data via the network. Also, at least one end node of said end nodes may be arranged to execute a service application that establishes application data traffic via the chain. A forecast-aware end node device may thereto have a network interface for exchanging data via the network, and a node processor arranged to execute at least one service application that establishes application data traffic via the chain. Hence, effectively, the application data traffic as required by the service application may be timely adapted in accordance with the forecast data, so that the application data traffic, or its processing, is adapted to cope with a forecasted change before actual occurrence of the change like a decrease in bandwidth or increase in delay time.

In an embodiment of the service application, adapting application data traffic may comprise at least one of
decreasing the application data traffic upon obtaining the forecast data indicative of a risk of data loss and/or transmission delay or the forecast data comprising a risk indicator representing a high risk level;
increasing the application data traffic upon obtaining the forecast data indicative of low risk of data loss and/or transmission delay. For example, decreasing may be applied when the forecast data comprises a risk indicator representing a relatively high risk level, while increasing may be applied when the forecast data comprises a risk indicator representing a relatively low risk level. The risk levels may be determined with respect to predetermined thresholds. So, effectively, the application data traffic may be adjusted using the forecast data to increase the overall experience of the user of the end node device.

Effectively, service applications are warned timely, before packets are actually delayed or lost. The throughput forecaster may determine a forecast and warns service applications running on end nodes for network problems before they actually occur, upon which the service applications may decide to lower the bitrate or do something else to deal with the forecasted changes. So, an early warning method is provided for service applications, based on expected capacity/quality changes in the network, e.g. at lower OSI layers such as the physical layer. The throughput forecaster may run on a stand-alone node, inside a (residential) gateway, inside a Network Controller or even in a distributed way implemented in various sub-units.

The throughput forecaster may collect performance data from links and/or nodes in the chain, e.g. from modems such as Wi-Fi, Powerline modems, DSL modems, 5G radio links, HN-modems, etc. The performance data is indicative of a performance level as detected while transferring the current data traffic. Examples of causes for low performance are receiving impulse noise due to electro-magnetic impulses from other devices, or crosstalk noise from other transmission signals, etc.

In an embodiment of the throughput forecaster, the processor is arranged to determine the forecast data based on comparing the performance data to at least one performance threshold. An advantage may be that a critical level of the performance level is easily detected, and the level crossing the threshold may be indicative of an imminent delay or loss of data packets, which may effectively result in a bandwidth decrease or an increase of the delay for the end node. Optionally, the processor is arranged to apply at least one weight factor to at least one respective excess over a respective threshold of respective performance data. So, a weighted combination of excess amounts of various performance parameters may be determined to derive a throughput forecast.

In an embodiment of the throughput forecasting, the forecast data is based on one or more of the following indicators. A first indicator may be a throughput margin based on a difference of an attainable bitrate and an actual bitrate in a link of the chain. A further indicator may be a rate excess with respect to a minimum safe bitrate, or an error excess with respect to an allowed number of error-recovery actions. A further indicator may be based on a change of the performance data in a preceding time interval. Optionally, a further indicator may be based on comparing to a respective threshold at least one of the throughput margin, the rate excess, the error excess and the change.

In an embodiment of the throughput forecaster, the forecast data may comprise a delay risk indicator indicating a risk of transmission delay. The forecast data may also comprise a loss risk indicator indicating a risk of data loss. The forecast data may also comprise a data risk indicator that represents a risk level according to one or more absolute or relative thresholds. For example, the risk level may represent one of the following situations: high risk level, medium risk level, low risk level or insignificant risk level as determined according to corresponding, predetermined risk level thresholds. An advantage may be that the forecast data having one or more of such risk indicators may be easily used by a service application to adapt the application data traffic.

In an embodiment of the throughput forecaster, the processor is arranged to adapt at least one of the thresholds or risk levels based on evaluating at least one actual data traffic parameter of a past time interval with respect to forecast data for that time interval. An advantage may be that the forecaster is self-adjusting based on past data, so that the forecast data may become more accurate over time, and may automatically adapt to a change in circumstances.

In an embodiment of the throughput forecaster, the processor is arranged to communicate with at least one of the end nodes and/or a network controller to obtain at least one resource identifier, a respective resource identifier identifying a respective resource in the chain for enabling said obtaining the performance data of the respective resource. For example, the processor may communicate with the end node so as to obtain data on the path a respective data stream follows to arrive at a destination end node. Based on such a path the network resources involved may be derived. An advantage may be that resources in the chain may be easily found and respective performance data can be obtained using the respective resource identifiers.

Optionally, the chain may have multiple parallel paths. These paths may be used in succession for coping with congestion, e.g. rerouting data to an alternative path. They may also be used in parallel for increasing the overall data capacity, e.g. bonding data through multiple paths, or may be used in a mix of both. In an embodiment of the throughput forecaster, the processor is arranged to identify multiple resources as used by the multiple paths. An advantage may be that the forecaster is aware of possible alternative paths, how much data flows through each of them, and may take into account a forecast based on the actually used paths.

In an embodiment of the throughput forecaster, the processor may be arranged to exchange requirements for providing forecast data with the forecast-aware end node and to provide the forecast data according to the requirements. Correspondingly, the forecast-aware end node may be arranged to exchange with the processor system the requirements for providing forecast data.

Optionally, the network further comprises a further processor system (called a further throughput forecaster) for monitoring traffic in the network, the further processor system being arranged to determine further forecast data representing a throughput forecast for a respective part of the chain based on respective performance data, the respective part of the chain being located in a further network domain different from a network domain where the forecast-aware end node is located. In an embodiment of the throughput forecaster, the processor is arranged to communicate with the further processor system and to determine the forecast data using the further forecast data. An advantage may be that the forecast may cover multiple domains.

In an embodiment, the end node device comprises the processor system as defined above. An advantage may be that the processor system embodying the throughput forecaster may now directly be coupled to and integrated in a forecast-aware end node, while the end node and throughput forecaster may share a single network interface.

It will be appreciated by those skilled in the art that two or more of the above-mentioned embodiments, implementations, and/or aspects of the invention may be combined in any way deemed useful.

Modifications and variations of the system, the devices, the server, and/or the computer program, which correspond to the described modifications and variations of the method, and vice versa, can be carried out by a person skilled in the art on the basis of the present description.

### BRIEF DESCRIPTION OF THE DRAWINGS

These and other aspects of the invention are apparent from and will be elucidated with reference to the embodiments described hereinafter. In the drawings,

FIG. 1 shows an example of a network having a throughput forecaster,

FIG. 2 shows a further example of a network having a throughput forecaster,

FIG. 3 shows a further example of a network having a throughput forecaster,

FIG. 4 schematically shows an example of a network having multiple throughput forecasters,

FIG. 5a shows a processing method for monitoring data traffic in a network,

FIG. 5b shows a service application method for adapting data traffic in the network,

FIG. 6 shows a network resource method for use in the network,

FIG. 7 shows a transitory or non-transitory computer-readable medium; and

FIG. 8 shows an exemplary data processing system.

It should be noted that similar items in different figures may have the same reference numbers, may have similar structural features, functions, or signals. Where the function and/or structure of such an item has been explained, there is no necessity for repeated explanation thereof in the detailed description.

### DETAILED DESCRIPTION OF EMBODIMENTS

The following describes several embodiments of the processor system embodying the throughput forecaster. First, some further general description of the technical concept of throughput forecasting is provided.

The proposed system of the throughput forecaster and further adapted network elements, called the forecasting approach, enables an early warning to service applications about expected congestion problems, before such congestions actually take place. Such a future congestion may then cause delays in the involved data streams, which may become a problem for latency-critical service applications resulting in that their service may freeze and/or show gaps. As an example, early warning like “high_risk”, “medium_risk” “low risk” or “insignificant_risk” may be send to a service application adapted to obtain to such forecast information. The forecast data may be updated as often as needed, in order to keep a service application informed about the actual threat that its content stream will be delayed in the near future. This information allows service application to act in time on such threats, so that the impact of expected congestion is minimal.

The forecasting approach is different from a bandwidth approach in which maximum, or recommended, bandwidth messages are send to a client, which is proposed in SAND (see ref [1]). SAND derives such bandwidth information by estimating the total bandwidth demand and by comparing it with available capacity. Moreover, such bandwidth approach may be complementary to the currently proposed forecasting approach. The SAND approach allows for improving the efficiency of streaming sessions between a server and its clients by making a fair estimate of expected network bandwidth, with hardly any knowledge on the actual bitrate through the links of each chain. It controls its clients to make a fair use of available bandwidth. But when congestion (from other data) causes more delay or lower bandwidth then was estimated, the involved clients can only adapt after such congestion has already occurred. The forecasting approach, however, enables timely adjusting application data traffic before it is actually hampered.

The forecasting approach is also different from known performance monitoring mechanisms that are known from physical layer devices like DSL modems, powerline modems, Wi-Fi modems 4G/5G radio links, etc, which may be reporting to a network management system. For example, indicators that may be reported include noise margins, number of bit swaps performed, error counters, number of retransmission performed, etc. While the proposed forecaster may obtain such performance data, it subsequently prepares the forecast and then transfers the forecast data to the end node. Instead, legacy network resources like modems are not equipped to provide any performance data to end nodes, or to derive risk factors related to future risks. For instance, legacy modems are not equipped to receive threshold values for guarding the bitrate margin, raise flags when one of these threshold values are violated or satisfied, and to signal such events according to a protocol, e.g. via event-driven messages other than periodical messages or on-request messages. Also, probing methods are known to let service applications decide how to adapt the source rate when congestion problems occur. Such methods apply probing to figure out what bitrates can be achieved between client and server, or when congestion occurs. Such probing methods are slow as they rely on congestion already taking place, and hence inherently are too late in adjusting application traffic before actual congestion occurs.

The forecasting approach is also different from control of application data traffic by a network authority. Control of application traffic at an end node requires permission to change settings in the end node by an authorized network device, expect a service application to obey commands from a network authority, etc. Forecasting however, requires no permission of the end node and does not change any setting directly. Instead, the service application itself decides how to use the forecasting data.

A further problem of control by a network authority is that viable decisions require service awareness. Without such an awareness, the controller cannot differentiate between different service needs. For example, an optimal QoE (Quality of Experience) means for one service to maintain low latency at the cost of image resolution (e.g. by temporary lowering the bitrate), and for another service to maintain image resolution at the cost of latency (e.g. by buffering packets to survive short congestions). Another problem of control may be that when the controller fails or cannot exchange messages with the service client, the service may fail.

The proposed throughput forecasting is “service agnostic” and allows each service application to decide for itself how to deal with the forecast data, e.g. to ignore the forecast, to squeeze a data rate (to preserve low latency, at the cost of image resolution), to buffer packets (to preserve source rate at a good average, at the cost of more latency), or do something else appropriate for the respective service, e.g. display a warning message for the user.

By using the forecasting approach, instead of control, no knowledge is needed about specific service requirements, and no need to hand-over permissions change settings in an end node to a controlling entity. Also, by using forecast data instead of sending a “maximum/recommended bandwidth” message, the service client can make better decisions about optimal QoE, and even make it content and/or end-user specific. The forecasting enables self-guidance of service applications, instead of control, and also enables the application data traffic service to continue when forecasting (temporarily) fails. The throughput forecaster identifies whether traffic of a service passes links or nodes in the chain that operate under high stress conditions and thereupon determines a probability that data flows may be obstructed or data packets may be delayed or get lost.

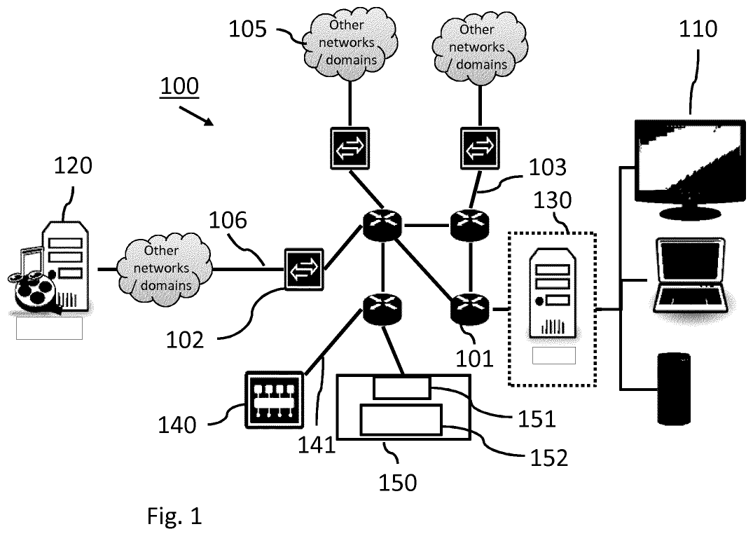

FIG. 1 shows an example of a network having a throughput forecaster. A network 100 is schematically shown having a multitude of network resources like nodes 101,102,130 coupled via links 103. So, the network has network resources including nodes and links connecting the nodes, and may have at least one network controller 140 having a network controller interface 141 for exchanging network control data. The network controller interface may be linked to the network, as schematically shown, or may be a separate control interface. The network controller is arranged to control one or more of the network resources, for example network switches or links. For example, in software defined networking, the network controller may be an SDN controller. The network may include various network domains 105. A node at the edge of a particular network may be called an edge node. The node may also be a network forwarding element, when connecting the network to a server end node or to another network.

The network has network resources including nodes and links connecting the nodes. The network is configurable for transferring data via a chain of network resources between a first end node 110 and a second end node 120. The chain enables application data traffic between the end nodes. Each end node has a network interface for exchanging data via the network. In the Figure, the node 130 is connecting the network to the first end node 110 constituted by a device running a service application, e.g. providing a client. The node 102 is connecting the network to the second end node 120 constituted by a device running a further service application, e.g. providing a server. The first end node may be called a client device, while the service application may be called a client. In the network as shown, the client device may be connected to a first node in the network, e.g. home gateway, which may also connect to other client devices. The Figure shows multiple client devices 110 such as a TV running a DASH client, a PC or laptop running a DASH client and a mobile phone running a DASH client. On such end node devices one or more service applications may constitute respective clients that require application data to be transferred.

The network is arranged for transferring application data like video streams between respective end nodes. Each respective stream is transferred via a respective associated chain of network resources. The chain enables bi-directional data traffic between the first end node and the second end node. For example, a stream of video data may be transferred between a server in one end node and a client in the other end node via the network.

The network as shown has a node 130 coupled to the first end node 110. In the example, the node has the function of a DANE (a DASH aware network element; DASH meaning Dynamic Adaptive Streaming over HTTP). Such a node constitutes a network resource in the chain.

At least one of the network resources in the chain is arranged to generate performance data representing a performance level of the data traffic at the network resource to enable forecasting. Such a network resource may have a resource network interface for exchanging the performance data via the network. Such forecasting-enabled network resource may, for example, generate one or more of the following performance data:
a bitrate margin representing how close an actual traffic bitrate approaches a maximum achievable bitrate through a link or node,
a noise level on a link,
a noise margin representing how close an actual noise level approaches a maximum allowed noise level on a link,
amount of errors in a preceding period,
amount of retransmissions to recover from errors;
amount of bit swaps performed in correcting errors,
bit loading per carrier,
signal-to-noise-ratio (SNR) margin per carrier,
seamless rate adaptation (SRA) steps performed,
forward error correction data, including CRC actions, Code Violations,
number of retransmissions in a predetermined interval,
buffer-fill of retransmission buffer,
parameters of a crosstalk matrix of a vectoring system for identifying worst-case disturbers,
number of idle symbols representing unused bitrate,
attainable bitrate provided by the modem.

The network as shown has a processor system 150 which may be called a throughput forecaster. The processor system has a communication interface 151 for exchanging data via the network and a processor 152 arranged to obtain the performance data from one or more network resources, for example one or more of the above-mentioned types of performance data. The processor is further arranged to determine forecast data representing a throughput forecast for the chain based on the performance data. The processor is further arranged to communicate with the end node associated with the chain to provide the forecast data to the service application in the end node as elucidated below. The processor system may further have embedded software and/or dedicated hardware circuits to calculate the forecast data. Examples of various interfaces and messages between the throughput forecaster, network resources and the end nodes, and optionally the network controller are described below. In practice, the processor system may be separate device, or may be embedded in other network devices, for example in the node 130 or the network controller 140.

At least one of the end nodes is arranged to execute a service application that establishes application data traffic via the chain. The service application communicates with the processor system 150 to the obtain the forecast data, and adapt the application data traffic based on the forecast data.

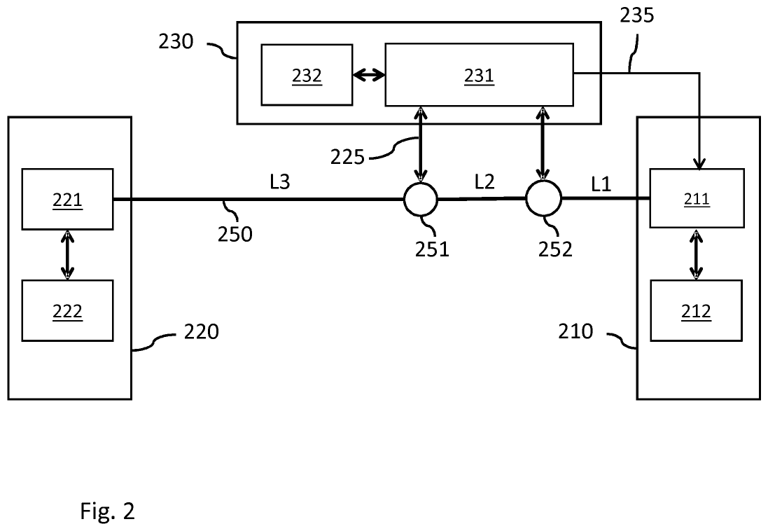

FIG. 2 shows a further example of a network having a throughput forecaster. A first end node 210 is coupled to a second end node 220 via a chain of network resources 250,251,252 in a network. The first end node has a network interface 211 and a processor 212 for executing at least one service application. The second end node has a network interface 221 and a processor 222 for executing a further service application.

The chain includes a connection 250, e.g. via a provider network, coupled to the second end node 220. As such, connection 250 may be constituted by a further sequence of network resources in the provider network, for example as shown in FIG. 1, but it will be considered as a single link L3 for now. The link L3 is coupled to a first node 251, e.g. home gateway or a PowerLine modem. Subsequently, a link L2 is formed to a second node 252, e.g. a WiFi transceiver coupled via a WiFi link L1 to the first end node 210. So, the chain between the end nodes comprises a sequence of network resources: link L1, node 252, link L2, node 251 and the network resources forming link L3. In detail, a practical chain may have a far greater number of network resources forming the data path between the end nodes. However, for the proposed throughput forecasting, it is sufficient if at least one, or a few, of the resources in the chain are cooperating so as to provide performance data as elucidated now.

The Figure shows a processor system 230 constituting a throughout forecaster having a processor 232 and a communication interface 231 for exchanging data via the network. The processor is arranged to obtain performance data 225 from one or more of the network resources in the chain. The processor has a calculation unit for determining forecast data 235 representing a throughput forecast for the chain based on the performance data. Subsequently, the processor will communicate with the first end node 210 via the network interface 231 to provide the forecast data 235.

In the example, the first end node 210 has a forecasting-aware service application, while the nodes 251,252 in the chain are network resources cooperating with the throughput forecaster and may be so-called forecasting-enabled modems, logically coupled to the throughput forecaster 230. Possible embodiments of each of these elements will be described below, as well as an embodiment of a forecasting evaluation unit that calculates the forecasting from the performance data of various sources.

An example of applying throughput forecasting by a service application for streaming content is to improve the Quality of Experience (QoE) for its user. The architecture in FIG. 2 shows a second end node 220 having a service application that provides content, connected with a first end node 210 having a service application that receives content. The data traffic, via the chain of network resources, between both service applications may be peer-to-peer (e.g. for video conferencing applications), may use a client-server model as described in [mpeg-dash-1] or may use some other model.

The first service application can exchange messages with the second service application via the links L1, L2 and L3. The first service application can also exchange messages with other applications (running on the same or another device), including exchanging messages for receiving forecasting data 235 with the throughput forecaster 230. The first service application can start subscribing itself to the service of a throughput forecaster by broadcasting a message into the network with the question if such a forecasting service is available. If not, there will be no reply, or a negative reply from some network controlling application somewhere in the network. The service application will then proceed as a legacy service application that is not forecasting-aware. When at a later moment in time a throughput forecaster announces itself, the service application can still proceed as described below.

In the event that the throughput forecaster 230 replies positive to said request (or as soon as it identifies itself), the service application and the throughput forecaster may exchange messages, starting with a handshaking/initiation session. An example of how such an exchange of messages may be similar to [mpeg-dash-5] where so called “SAND messages” are exchanged between “DASH clients” and “DANEs”.

During the above initiation, the throughput forecaster 230 may, for instance, message to the first service application about its forecasting capabilities. During the initiation, the first service application may message to the forecaster (a) at what bitrate it would like to receive a content stream from a second service application, (b) within what delay, (c) the same information about content transmitted to a second service application, (d) what kind of forecasting information (or how frequent) the first service application would like to receive, etc.

Subsequently, the first service application can start (or proceed) the exchange of messages with a second service application to receive streaming content, for instance, by using the adaptive streaming methods described in [mpeg-dash-1].

During such a streaming session, the first service application may receive messages from the throughput forecaster about the risk that in near future requested packets with content may be delayed or dropped by the network so that requested content from the second service application may arrive too late or arrive not at all. An example of such a forecast is a message that indicates that the risk of packet delay or packet-loss is ‘high’, “medium”, “low” or “insignificant”. The throughput forecaster 230 may repeat or update these risk warnings as often as needed.

The first service application may then decide how to respond on such forecasting information. An option is to ignore (most of) these forecasting messages, and to take the risk of delayed or missing packets. This may be the strategy of choice when low-latency is irrelevant and the impact of delayed packets can be minimized via buffering. Another option is that the first service application messages the second service application that it should adapt its rate of streaming content using the adaptive methods described in [mpeg-dash-1]. This may be the strategy of choice when low-latency is very important and that continuation of sound and fluent movements is more important than image resolution. So, the second service application may reduce the image resolution on request of the first service application, in order to lower the bit rate of streaming content. This reduces the risk that packets with content are delayed or dropped. Such reduction is expected to keep the movements in images fluently, albeit at lower image resolution. The first application accepts the risk of a false alarm, i.e. the throughput forecast being too pessimistic and the applied reduction of resolution not being necessary.

Another aspect of throughput forecasting is the capability of detecting local performance in the chain during handling the data traffic for the respective service applications. Performance data, such as an indication that packet delay or packet loss may occur soon, are detectable by nodes, e.g. modems. Network modems may continuously monitor performance of the involved links, and this performance information can be provided to the throughput forecaster. Such a modem may be a part of a wireless link, such as WiFi access points, WiFi repeaters, 5G Radio heads, free-optical space modems (e.g. using infra-red light), etc. Such a modem may also be a part of a wired link, such as a DSL modem (Digital Subscriber Line, like ADSL, VDSL, G.fast), a PLC modem (Power Line Communication), an optical modem at a fiber link, etc. Modem devices that are prepared for providing such information to a throughput forecaster are referred to as “forecasting-enabled modems”.

In a practical network environment, forecasting-enabled modems may be implemented as follows. At start-up, a forecasting-enabled modem in a node may start announcing itself by broadcasting a message to the network with the question if it should provide a throughput forecaster with information. If not, there will be no reply, or a negative reply from some network controlling application in the network. The modem will then proceed as a legacy modem that is not forecasting enabled. When at a later moment in time a throughput forecaster still announces itself, the modem can proceed as described below.

If a throughput forecaster replies positive to the above request, or as soon as a forecaster identifies itself, the modems and the throughput forecaster can exchange messages, e.g. starting with a handshaking and initiation session. An example of how such an exchange of messages may look like can be found in [mpeg-dash-5] where so called “SAND messages” are exchanged between “DASH clients” and “DANEs”. During such initiation, the modem may exchange information to the throughput forecaster about (a) the type of modem, (b) which performance data are available for forecasting, (c) what are its capabilities, etc. The performance data is further explained below.

During such initiation, the throughput forecaster may exchange information to the modem about (a) which performance data are to be used for the forecasting, (b) about the involved threshold values for raising violation events, (c) about the performance data that should report actual values, (d) how often such messages should be send, etc. Next, the modem may proceed with transmitting and receiving data bits, in particular application data, through the involved link.

The transmission of packets through a link is often stressed by impairments from varying environmental effects, which are often a dominant cause why packets get suddenly delayed, due to retransmission, or get lost. State-of-the art modems, such as DSL modems are therefore continuously monitoring the performance of this transmission/reception, and they adapt their line coding on the fly to ensure reliable transmission. Example of stress causes are (a) receiving impulse noises due to electro-magnetic impulses from other devices, (b) receiving crosstalk noises from other transmission signals, (c) connecting and disconnecting other (disturbing) modems, etc. Examples of stress mitigation techniques of modems are (a) the use of forward error correction via line codes with redundancy, (b) swapping bits to carriers in other frequency bands, (c) retransmitting packets if the forward error correction has failed at the cost of using higher bitrates, (d) changing the constellation size of the line code at the cost of lower attainable bitrates, (e) changing the transmit power, (f) cancelation of crosstalk noise via vectoring, etc.

The above monitoring and mitigation techniques provide relevant performance data for the throughput forecaster. In various embodiments, performance data which a forecasting-enabled modem may measure and subsequently message to a throughput forecaster may include one or more of the following:
Has the bitrate margin reached a value below a given threshold, or what is the actual bitrate margin. The margin is the distance between the actual data rate through the link and the maximum attainable data rate as evaluated by the modem.
Has the noise margin reached a value below a given threshold, or what is the actual noise margin. This margin is the distance between the actual noise level and the noise level that prevents all further transmission.
Has the number of corrected errors in a given time interval exceeded a given threshold or simply what is the current number of successful and unsuccessful corrected errors. Forward error correction can identify if it was applied and if it repaired the error(s).
Has the number of bit swaps in a given time interval exceeded a given threshold or simply has a bit swap taken place. Bit swaps is a common feature of modems to change the distribution of bits, loaded over multiple carriers, if certain frequency bands are more disturbed then others.
Has the number of retransmissions in a given time interval exceeded a given threshold, or the number of retransmissions in a period. Retransmission is a common feature of modems to transmit a damaged packed another time when the forward error correction has failed.
Has rate adaptation been applied, and what are the remaining margins (noise & bitrate). Rate adaptation is a common feature of modems to change the total number of bits packed on all involved carriers. This relaxes or tighten the actual signal-to-noise ratio and thus the bitrate margin and noise margin.

In the examples, various thresholds may have values as instructed by the throughput forecaster, or thresholds may be predetermined or set during installation or configuration of a network. When an embodiment of a forecasting-enabled modem observes that a performance indicator passes a given threshold, it may raise a “threshold violation” flag when the stress level increases from low to high or it raises a “threshold satisfaction” flag for the opposite direction. Such a threshold may be implemented as a pair of two values to enable a hysteresis between raising “satisfaction” and “violation” flags. Each performance data may have multiple threshold pairs to enable a distinction between the severity of these stressors. The modem may observe multiple stress indictors in this way.

In an embodiment, a forecasting-enabled modem handles the detection of threshold violations and satisfactions within the modem, based on the thresholds as received from the throughput forecaster. Such a modem reports messages with violation/satisfaction flags to that forecaster. An alternative approach is that modems regularly report the actual value of each performance data to the throughput forecaster and leave the detection of threshold violations to the throughput forecaster. This alternative approach simplifies the modem design but causes more traffic of messages. Optionally, such modem pushes messages to the throughput forecaster, each time a violation or satisfaction flag is raised. Alternatively, the modem may wait until the throughput forecaster pulls a message to report the current status of these performance data, or apply a mix of push and pulling messages.

Optionally, the actual reporting (push, pull or a mix of both), as well as the involved thresholds and time intervals, may be determined based on negotiation between modem and throughput forecaster. During the negotiation various performance criteria like said threshold may be transferred to the network resource. The resource may then monitor the actual performance levels with respect to the criteria, and may report when the actual levels violate said criteria, e.g. exceed a threshold. For example, a modem may receive a threshold for bitrate margin. The modem, on its initiative, may report the excess of the bitrate margin threshold by “pushing” a report to the forecaster. Pushing a report, or delaying a report for a predetermined period, and/or making the reporting and/or timing dependent on the amount of excess may be preset, or dynamically negotiated, or instructed via reporting instructions by the forecaster.

The processor system constituting the throughput forecaster may be implemented as follows. An aspect of throughput forecasting is the capability to collect relevant performance data from forecasting-enabled modems as described above. Subsequently, the performance data is to be processed into suitable forecasting information, which is then provided to forecasting-aware service applications.

In a practical network environment, the throughput forecaster may be implemented as follows. At start-up, the throughput forecaster may start announcing itself to modems by broadcasting a message to the network with the question if forecasting-enabled modems are available in the network. If not, there will be no reply, or a negative reply from some network controlling application in the network. In that case, the throughput forecaster simply waits until a first forecasting-enabled modem announces itself at a later stage in time, and then proceeds as described below. However, if one or more forecasting-enabled network resources reply positive, or if they identify themselves, the throughput forecaster and respective resources may exchange messages, starting with a handshaking/initiation session. This is described before with the embodiment of the forecasting-enabled modems.

The throughput forecaster may announce itself to service applications by broadcasting a message to the network with the question if forecasting-aware service applications are seeking a forecasting service. If not, there will be no reply, or a negative reply from forecasting-aware service applications and the throughput forecaster may wait until a service application requests for a subscription on a forecasting service. If one or more forecasting-aware service applications reply positive, or if they identify themselves, the throughput forecaster and respective service applications may exchange messages, starting with a handshaking/initiation session.

In operation, the throughput forecaster continually combines relevant performance data about the links and nodes in the chain, e.g. as received from via the modems, and evaluates the performance data to arrive at the forecasting information for each service application with a forecasting subscription. Such a forecast may be as basic status like “high_risk”, “medium_risk”, “low risk” and “insignificant_risk”. These values indicate the current risk for application data traffic that sudden impairments in the weakest link may hit its packets so that these packets are to be retransmitted and thus delayed. An evaluation is described hereafter.

In an embodiment, the forecasting evaluation as described is implemented within the throughput forecaster as a separate device. In practice, a distributed approach where parts of the evaluation are implemented within forecasting-enabled modems, in a separate PC or home gateway, or elsewhere is not excluded.

An example embodiment of a forecasting evaluation monitors the bitrate margin, for each link “k” (121, 122, 123), by using the following variables:
BR_red_good[k], BR_red_bad[k], which are a pair of threshold values for link “k”, indicating when the forecasting evaluation considers the current stress level as a “high risk” for a content stream that its packets do not arrive in time or do not arrive at all. Both threshold values are forwarded to and stored in the involved modem so that it can raise a “red-violation” flag as soon as the bitrate margin gets worse than threshold value BR_red_bad[k], or a “red-satisfaction” flag as soon as the bitrate margin gets better than BR_red_good[k].
BR_orange_good[k], BR_orange_bad[k], which are another pair of threshold values for link “k”, indicating when the forecasting evaluation considers the current stress level as a “medium risk” for a content stream that its packets do not arrive in time or do not arrive at all. They are handled by the modem in a similar manner as the red thresholds, but only with a different pair of threshold levels.
BR_green_good[k], BR_green_bad[k], which are two more threshold values for link “k”, indicating when the forecasting evaluation considers the current stress level as a “low risk” for a content stream that its packets do not arrive in time or do not arrive at all. They are handled by the modem in a similar manner as the red and orange thresholds, but only with yet another different pair of threshold levels.
BR_risk_state[k], which keeps track for link “k” of the severity of the current stress level. In this example embodiment it can have one of the following four values: “high_risk”, “medium_risk”, “low risk” or “insignificant_risk”. Each time the modem raises one of the above-mentioned violation or satisfaction flags, the modem forwards such event to the forecasting evaluation, causing this variable to be updated in value to high_risk when the modem raised a “red violation” flag; to medium_risk when the modem raised a “red satisfaction” or “orange violation” flag, to low risk when the modem raised an “orange satisfaction” or “green violation” flag, or to insignificant risk when the modem raised a “green satisfaction” flag.
BR_sum[k], which is the sum of all bitrates of content streams with a forecasting subscription, that are expected to flow through link “k”. These bitrates are announced by the involved service applications with a forecasting subscription.
BR_scaling_xx[k], which are scaling factors to calculate the threshold values from BR_sum[k]. Each time a service application causes the value in BR_sum[k] to change, the threshold values for red, orange and green are recalculated accordingly to the current scaling factors and the threshold values in the modems are updated accordingly. An example is as follows:
BR_red_bad[k]=BR_scaling_red_bad[k]*BR_sum[k], for instance 50%
BR_red_good[k]=BR_scaling_red_good[k]*BR_sum[k], for instance 70%
BR_orange_bad[k]=BR_scaling_orange_bad[k]*BR_sum[k], for instance 100%
BR_orange_good[k]=BR_scaling_orange_good[k]*BR_sum[k], for instance 140%
BR_green_bad[k]=BR_scaling_green_bad[k]*BR_sum[k], for instance 200%
BR_green_good[k]=BR_scaling_green_good[k]*BR_sum[k], for instance 280%

Next, the forecasting evaluation may calculate, for each content stream “q” with a forecasting subscription, an overall risk value for that particular stream from all individual risk values of the involved cascade of links in the chain. An example embodiment stores these values in STREAM_risk_state[q], and evaluates it as the worst-case value of BR_risk_rate[k] for each involved link “k”. Thus, links that are not used for content stream “q” are simply ignored for evaluating the value STREAM_risk_state[q]. Each time this value changes, the throughput forecaster reports the involved STREAM_risk_state[q] value to the involved service application, and by doing so, it updates the “forecast” for that stream. This forecast value is essentially an indication about the risk in the weakest link that sudden peaks in impairment will damage or block packets of a content stream. In such a case, these packets are to be retransmitted and thus delayed.

In practice, a throughput forecast may be right, but can also be too optimistic or too pessimistic. It is up to the service application to decide what to do with the forecast. In an embodiment the forecasting evaluation is equipped with the capability of learning. Such learning may reduce the probability that forecasts remain too optimistic or too pessimistic. When for instance the stress in a specific link “k” is classified as “high risk” for content streams in that link, but for a given period of time no error is observed in that link, then the forecasting was apparently too pessimistic. Subsequently, the scaling factors BR_scaling_xxx[k] may be decreased, e.g. on the fly in small steps, to make the forecast less pessimistic, respectively increased when too optimistic. Each adjustment step of a scaling factor may cause threshold values (for red, orange and green) to change accordingly, so that the value in BR_risk_state[k] will be updated, the resulting STREAM_risk_state[q] will be updated as well, and updated forecasts will be reported to the involved service applications.

In the above example embodiment, the performance data “bitrate margin” has been monitored for determining the forecast, and the embodiment has used reported errors and retransmissions to learn about how to adjust these predictions on the fly. However, in a further embodiment, multiple stress-indicators may be monitored simultaneously for evaluating a forecast.

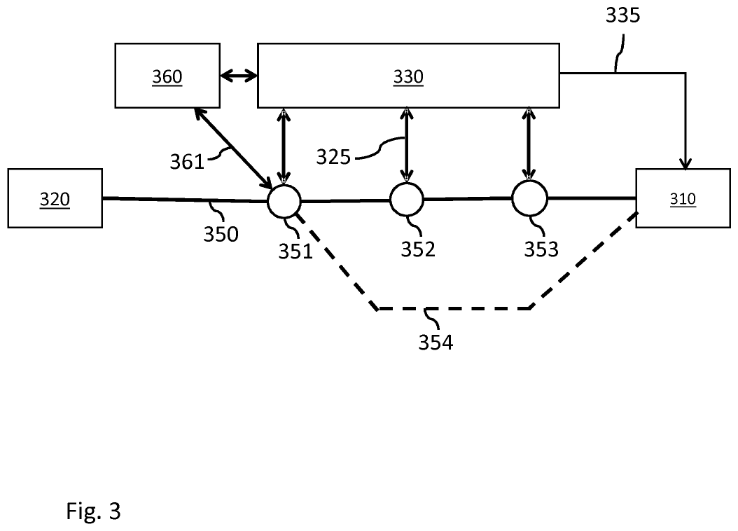

FIG. 3 shows a further example of a network having a throughput forecaster. A first end node 310 is coupled to a second end node 320 via a chain of network resources 350,351,352,353 in a network. Similar to FIG. 2 each end node has a respective network interface and processor for executing at least one service application. The chain includes a connection 350, e.g. via a provider network, coupled to the second end node 320, then a first node 351, then a second node 352, e.g. home gateway or a PowerLine modem. Subsequently, a link is formed to a third node 353, e.g. a WiFi transceiver coupled via a WiFi link to the first end node 310. In the Figure, the network also has an alternative link 354 directly from the first node 351 to the first end node 310, which is currently not used as indicated by dashed lines. The network also has a network controller 360, which may be coupled to multiple nodes in the network, e.g. in the domain of the provider. The network controller may also be coupled to first node 351 for controlling the node and determining the configuration of the chain as indicated by arrow 361. For example, the network controller may also determine which path in the chain is actually used, the path via the second and third node or the alternative path.

The Figure shows a processor system 330 constituting a further example of a throughout forecaster, like in FIG. 2 having a processor (not shown) and a communication interface (not shown) for exchanging data. The processor is arranged to obtain the performance data 325 and determine the throughput forecast as elucidated below.

The Figure shows a more advanced architecture where the content stream between a first forecasting-aware service application and a second one has multiple connection possibilities. The application data traffic may flow through the upper links and nodes or through alternative path 354. In such a case the forecasting will be based only on the links that are being used by the content stream, and that requires a more advanced throughput forecasting. A possible embodiment of forecasting with multiple connections is described now.

When a first service application seeks forecasting from the throughput forecaster 330, the throughput forecaster has also to discover which links will be used by the data traffic. As such, nor the throughput forecaster nor the service application have this knowledge. A solution for a possible embodiment is to ask a controlling entity in the network about the path that is actually used. The embodiment in FIG. 3 shows the network controller 360 in the network, which is assumed to have such network configuration information. The throughput forecaster 330 is arranged to exchange messages with the network controller to request for the involved resources in the chain. Additionally, the forecaster may be arranged to receive updates of such information, e.g. when the flow changes to another path. To enable that, the service application may provide the throughput forecaster with a “Flow-identifier” to identify the content stream, and the throughput forecaster passes that identifier to the network controller. The network controller may response by sending a list of involved links. Such a flow-identifier may be the flow identifiers that are commonly used within SDN networks, but it can also be the well-known “5-tuples” (source IP, source port, destination IP, destination port, protocol) that are commonly used to identify TCP connections.

If there is no network entity that is enabled to respond directly, the throughput forecaster may exchange additional messages with the first service application to identify the involved nodes of the path. In a possible embodiment, the service application may start a well-known “traceroute” session between the end nodes 310 and 320 to identify the involved node numbers, and report that route back to the throughput forecaster. The service application may repeat the traceroute procedure as often as desired, to keep the information on the chain up to date in the throughput forecaster.

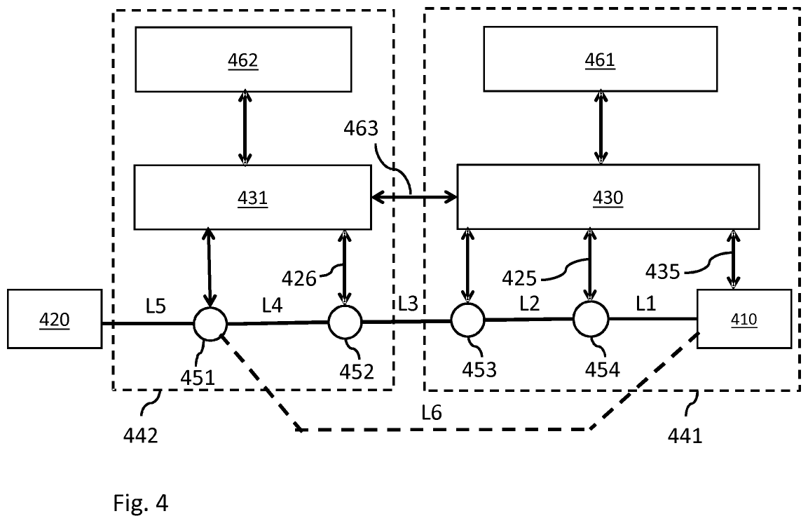

FIG. 4 schematically shows an example of a network having multiple throughput forecasters. A first end node 410 is coupled to a second end node 420 via a chain of network resources, including nodes 451,452,453,454 and links L1,L2,L3,L4,L5 in a network. Similar to FIG. 2 each end node has a respective network interface and processor for executing at least one service application. The chain includes a connection L5 coupled from the second end node to a first node 451, e.g. via a provider network using a further set of network resources, then to a second node 452 via link L4, for example formed by fiber modems. Next, via link L3 to a third node 453, e.g. using DSL to a home gateway. Subsequently, a link L2 is formed to a fourth node 454, e.g. by PowerLine modems. Next, a link L1 is formed between the fourth node 454 and the first end node 410, e.g. by WiFi transceivers coupled via WiFi. In the Figure, the network also has an alternative link L6 directly from the first node 451 to the first end node 410, which is currently not used as indicated by dashed lines, e.g. a 4G or 5G radio connection of a telecom provider.

The network has a first domain 441, e.g. a local or home network, having a first network controller 461, which may be coupled to multiple nodes in the first domain. The first network controller may be implemented in a home gateway or in a router, or in a PC. A second part 442 of the network may represent a domain of a provider having a second network controller 462. To enable traffic steering in both domains between different operators/owners, the network control may be distributed. In this example a “Local/Home Network Controller” exchanges messages with the devices within the local network, and one (or more) “Access/Core Network Controller(s)” exchange messages with devices in the respective access and core network. The network controllers may be coupled to respective nodes in the respective domains for controlling and configuring the chain. At least part of the chain may also be configured manually, or during installation, or during use, e.g. by the network. The processor system 430 may ask a controlling network entity in the network about which path in the chain is actually used, the path via L1,L2,L3,L4 or the alternative path via L6, or in the absence of such a network entity use an alternative approach as described before.

The Figure shows a first processor system 430, called a local throughput forecaster, in the first domain, and a second processor system 431, called a remote throughput forecaster, in the second domain. Each forecaster may have a processor (not shown) and a communication interface (not shown) for exchanging data, as described with FIG. 2. The local forecaster 430 is arranged to obtain performance data 425 and determine the throughput forecast in the local network domain, and the remote forecaster 431 is arranged to obtain performance data 426 and determine the throughput forecast in the provider network domain, as further elucidated below.

The Figure shows a more advanced architecture where the application data travels between a first forecasting-aware service application 410 and a second one 420 via links in multiple domains. Such domains are characterized by the property that they are under control of different entities that may not allow each other to get access to nodes inside their domain. The example shows a local network 441, controlled by equipment from a home owner, and an access network 442 controlled by equipment from an access network provider. In such multi-domain networks, content streams may be hampered or interrupted at various links. The local throughput forecaster 430 may not have access to remote nodes 451,452 for exchanging messages for performance and forecast monitoring. So, it is proposed that the access network provider provides a further, remote forecaster 431 inside the provider domain. The remote forecaster is arranged to communicate with the local throughput forecaster 430 to provide forecasting information about links in the access network. Optionally, further domains crossed by the chain may have further forecasters, which may communicate with the second or first forecaster to provide the first forecaster 430 with throughput forecast data for a large part or even the full chain.

An embodiment of throughput forecasting in a multi domain environment may then be implemented as follows. After start-up, when the first throughput forecaster 430 has announced himself within the local network as described before, that throughput forecaster 430 can also broadcast a message to the network with the request that it seeks forecasting information about content streams flowing outside its own domain. If there is no reply, or a negative reply from some other node in the network, then the first throughput forecaster 430 proceeds as if no errors occur outside its own domain. If there is a positive reply from some node, maybe from a local network controller 461 or from an access network controller 462, then the first throughput forecaster 430 exchanges messages with such controllers to identify from which node it may obtain forecasting information. The reply may contain address information of a second throughput forecaster 431, if the first throughput forecaster 430 may exchange messages directly with that second throughput forecaster 431. Also, the reply may contain address information from some intermediate entity configured to pass those messages to relevant other throughput forecasters outside the local domain.

Next the first throughput forecaster 430 exchanges messages to subscribe itself to forecasting information from the second forecaster 431 about one or more content streams, each with its own identifier. These messages may be exchanged directly between the two throughput forecasters, or be exchanged via intermediate nodes. This process may be similar to how a first service application subscribes its content stream(s) to a local throughput forecaster, with the difference that the second forecaster 431 provides forecasting information for part of the chain crossing the provider domain. The boundaries of the provider domain may, for example, be at a gateway in an edge node 453 when the link L3 is involved or at an end node if a hand-held device uses a radio link L6.

Each time the first forecaster 430 receives external forecast data 463 about content streams outside the local network, it may combine the external forecast data with internal forecasting information about the same streams through links within the local network to evaluate overall forecast information for the entire content stream. An embodiment of such an evaluation can be as simple as selecting the worst-case value of the internal and external forecast values, and sends that value as overall forecast to the involved service application.

Such approach can easily be extended to multiple throughput forecasters within multiple domains, e.g. when a home, an access network as well as a core network are involved, by repeating for each domain the approach as described above.

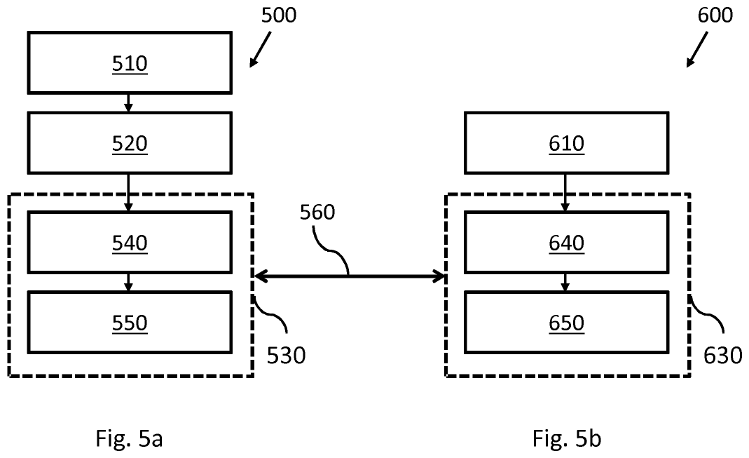

FIGS. 5a and 5b in combination show an example of throughput forecasting of data traffic in a network. The network, configured to provide a chain of network resources between two end nodes, has been described above. At least one of the network resources in the chain is arranged to generate performance data representing a performance level of the data traffic at the network resource.

FIG. 5a shows a processing method for monitoring data traffic in a network. The processing method 500 is arranged to perform throughput forecasting and may be executed in a dedicated throughput forecasting device, or may be implemented in a network resource or a network controller. Alternatively, the processing method may be implemented in an end node. At least one end node of said end nodes is arranged to execute a service application that establishes application data traffic via the chain, as further elucidated below with reference to FIG. 5b.

The processing method, in a first stage 510, obtains the performance data from one or more network resources in the chain. In a next stage 520, the method determines the forecast data representing a throughput forecast for the chain based on the performance data. The steps for obtaining the performance data and calculating the forecast data may be repeated continuously, as long as a particular chain is operational.

Subsequently, in a communication stage 530 the method communicates with the end node to provide the forecast data 560, as schematically indicated by an arrow. In a first substage 540 of the communication, the method may determine which forecast data has to be reported, e.g. according to a reporting request received from the end node or service application. Subsequently, in a reporting substage 550, a message exchange with the end node is executed. Optionally, it may be determined whether the forecast data has been significantly changed, and only if so, the reporting may be executed to the service application. For monitoring data traffic, the stages as shown may be repeated continuously, as long as at least one respective chain enabling application data traffic is operational and forecast data for the respective chain is requested.

FIG. 5b shows a service application method for adapting data traffic in the network. The service application method 600 may be executed at one of the end nodes. The network further has a throughput forecaster as described above.

The service application method, in a first stage 610 initially establishes application data traffic via the chain, according to network communication protocols known as such.

Subsequently, in an operational stage 630 the method first communicates with the throughput forecaster in a communication stage 640 to obtain the forecast data 560, as schematically indicated by an arrow. Next, in an adaptation stage 650, the method proceeds to adapt the application data traffic based on the forecast data.

It is to be noted that the application method, in the adaptation stage, autonomously determines whether or not, and in which way, to adapt the data traffic in view of the receive forecast data. The adaptation may depend on the actual and future need for data traffic via the chain, as known to, or estimated by, the application service. The forecast data does not control any data traffic setup or adaptation. Instead, depending on a particular type of forecast data, the application may decide whether or not, or to which degree, to take the forecast data into account. Effectively, the service application is enabled to provide the best possible service to the end user, in view of a predicted network data transfer capability.

In an embodiment of the service application method said adapting stage 650 for the application data traffic may involve decreasing the application data traffic upon obtaining the forecast data indicative of a risk of data loss and/or transmission delay. Similarly, if the forecast data contains a risk indicator representing a high-risk level, the adapting may involve decreasing the application data traffic. For example, the service application may decide to decrease the resolution of a video stream. Also, the service application may maintain the application data traffic, but issue a warning to the user or a confirmation of the user to decrease the resolution. Correspondingly, upon obtaining the forecast data indicative of low risk of data loss and/or transmission delay, or the forecast data comprising a risk indicator representing a low-risk level, the adapting may involve increasing the application data traffic.

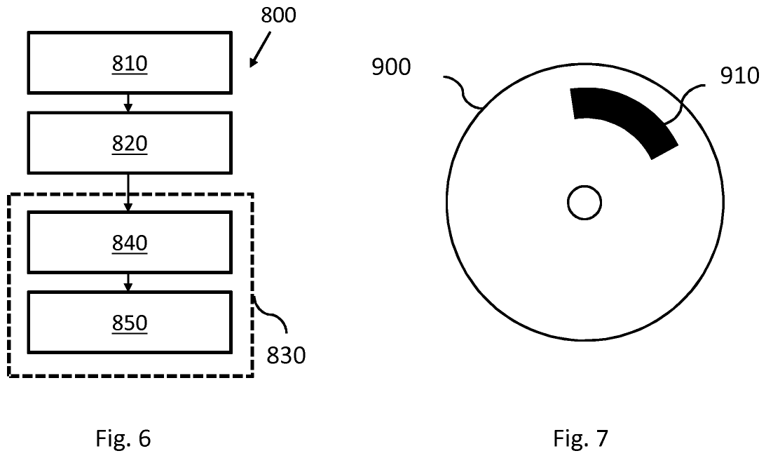

FIG. 6 shows a network resource method 800 for use in the network as described above, having said chain between end nodes and the throughput forecaster. The network resource method may be implemented in a dedicated performance detecting devices, or may be implemented in a network resource like a modem providing a link in the chain. The network resource has a resource network interface for exchanging performance data via the network.

In a first stage 810, the method receives performance criteria. For example, the method may communicate with a throughput forecaster that requests or commands a particular type of performance data with respect to the criteria. For example, the criteria may include a noise level or noise type that is to be detected and reported upon occurring. Next, in a stage 820, the method generates the performance data representing a performance level of the data traffic at the network resource.

Subsequently, in a reporting and communication stage 830 the method communicates via the network to the processor system to provide the performance data taking into account the performance criteria. In a first substage 840 of the communication, the method may determine which performance data has to be reported, if any, e.g. according to reporting criteria received from the throughput forecaster. Subsequently, in a reporting substage 850, a message exchange with the throughput forecaster is executed to provide the performance data in accordance with the performance criteria via the network to the processor system. Optionally, it may be determined whether the performance data has been significantly changed, and only if so, the reporting may be executed to the forecaster.

FIG. 7 shows a transitory or non-transitory computer readable medium, e.g. an optical disc 900. Instructions for the computer, e.g., executable code, for implementing one or more of the methods as illustrated with reference to FIGS. 5 and 6, may be stored on the computer readable medium 900, e.g., in the form of a series 910 of machine readable physical marks and/or as a series of elements having different electrical, e.g., magnetic, or optical properties or values. The executable code may be stored in a transitory or non-transitory manner. Examples of computer readable mediums include memory devices, optical storage devices, integrated circuits, servers, online software, etc.

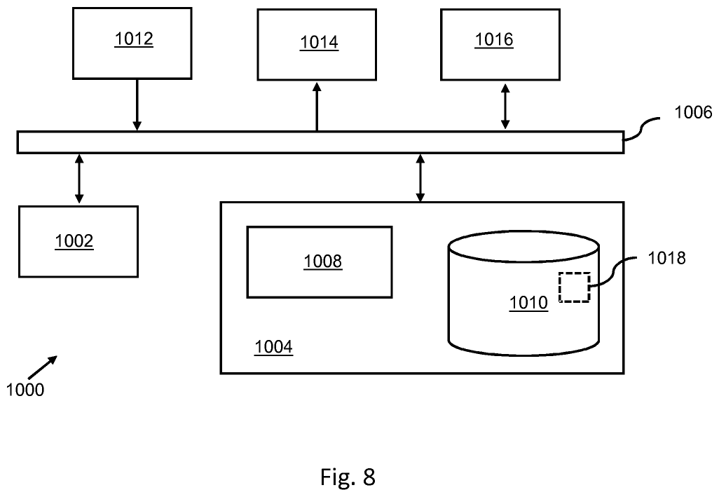

FIG. 8 shows a block diagram illustrating an exemplary data processing system that may be used in the embodiments of this disclosure. Such data processing systems include data processing entities described in this disclosure, including, but not limited to, the processor system embodying the throughput forecaster and the end node executing the service application. Data processing system 1000 may include at least one processor 1002 coupled to memory elements 1004 through a system bus 1006. As such, the data processing system may store program code within memory elements 1004. Further, processor 1002 may execute the program code accessed from memory elements 1004 via system bus 1006. In one aspect, data processing system may be implemented as a computer that is suitable for storing and/or executing program code. It will be appreciated, however, that data processing system 1000 may be implemented in the form of any system including a processor and memory that is capable of performing the functions described within this specification.

Memory elements 1004 may include one or more physical memory devices such as, for example, local memory 1008 and one or more bulk storage devices 1010. Local memory may refer to random access memory or other non-persistent memory device(s) generally used during actual execution of the program code. A bulk storage device may be implemented as a hard drive, solid state disk or other persistent data storage device. The processing system 1000 may also include one or more cache memories (not shown) that provide temporary storage of at least some program code in order to reduce the number of times program code must be retrieved from bulk storage device 1010 during execution.

Input/output (I/O) devices depicted as input device 1012 and output device 1014 may optionally be coupled to the data processing system. Examples of input devices may include, but are not limited to, for example, a microphone, a keyboard, a pointing device such as a mouse, a touchscreen or the like. Examples of output devices may include, but are not limited to, for example, a monitor or display, speakers, or the like. Input device and/or output device may be coupled to data processing system either directly or through intervening I/O controllers. A network interface 1016 may also be coupled to, or be part of, the data processing system to enable it to become coupled to other systems, computer systems, remote network devices, and/or remote storage devices through intervening private or public networks. The network interface may comprise a data receiver for receiving data that is transmitted by said systems, devices and/or networks to said data and a data transmitter for transmitting data to said systems, devices and/or networks. Modems, cable modems, and Ethernet cards are examples of different types of network interface that may be used with data processing system 1000.

As shown in FIG. 8, memory elements 1004 may store an application 1018. It should be appreciated that the data processing system 1000 may further execute an operating system (not shown) that may facilitate execution of the application. The application, being implemented in the form of executable program code, may be executed by data processing system 1000, e.g., by the processor 1002. Responsive to executing the application, the data processing system may be configured to perform one or more operations to be described herein in further detail.

In one aspect, for example, the data processing system 1000 may represent a forecaster. In that case, the application 1018 may represent an application that, when executed, configures the data processing system 1000 to perform the various functions described herein with reference to the forecaster, or in general the processing system embodying the forecaster, and its processor and controller. Here, the network interface 1016 may represent an embodiment of the forecaster network interface. In another aspect, the data processing system 1000 may represent a end node device. In that case, the application 1018 may represent a service application that, when executed, configures the data processing system 1000 to perform the various functions described herein with reference to a forecasting enabled service application.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

### ACRONYMS

| | |
|---|---|
| DANE | DASH aware network element |
| DASH | Dynamic Adaptive Streaming over HTTP |
| DSL | Digital subscriber line |
| HTTP | Hypertext Transfer Protocol |
| MPEG | video encoding standard of the Moving Picture Experts Group |
| QoE | quality of experience |
| SAND | server and network assisted DASH |
| SDN | software defined networking |

### REFERENCES

[1] MPEG DASH, “Information technology—Dynamic adaptive streaming over HTTP (DASH)—Part 5: Server and network assisted DASH (SAND)”, ISO/IEC CD 23009-5, 19 Feb. 2015
[2] MPEG DASH, “Information technology—Dynamic adaptive streaming over HTTP (DASH)—Part 1: Media presentation description and segment formats”

1. Processor system for monitoring data traffic in a network, the network comprising network resources including nodes and links connecting the nodes, and the network being configurable for transferring data via a chain of network resources enabling application data traffic between a first end node and a second end node;
wherein at least one of the network resources in the chain is arranged to generate performance data representing a performance level of the data traffic at the network resource and to exchange the performance data via the network;
wherein at least one end node of the end nodes is arranged to
execute a service application that establishes application data traffic via the chain,
communicate with the processor system to obtain forecast data, and
adapt the application data traffic based on the forecast data; and
wherein the processor system comprises
a communication interface for exchanging data via the network and
a processor arranged to
obtain the performance data,
determine the forecast data representing a throughput forecast for the chain based on the performance data, and
communicate with the end node to provide the forecast data.

2. The processor system as claimed in claim 1, wherein
the processor is further arranged to determine the forecast data based on comparing the performance data to at least one performance threshold.

3. The processor system as claimed in claim 1, wherein the forecast data is based on at least one of:
a throughput margin based on a difference of an attainable bitrate and an actual bitrate in the chain,
a rate excess with respect to a minimum safe bitrate,
an error excess with respect to an allowed number of error-recovery actions,
a change of the performance data in a preceding time interval, or
comparing to a respective threshold at least one of the throughput margin, the rate excess, the error excess and the change.

4. The processor system as claimed in claim 1, wherein the forecast data comprises a particular indicator, the particular indicator being at least one of:
a delay risk indicator indicating a risk of transmission delay,
a loss risk indicator indicating a risk of data loss, or
a data risk indicator that represents a risk level according to one or more absolute or relative thresholds.

5. The processor system as claimed in claim 1, wherein the processor is further arranged to adapt at least one of the thresholds or risk levels based on evaluating at least one actual data traffic parameter of a past time interval with respect to forecast data for that time interval.

6. The processor system as claimed in claim 1, wherein the processor is arranged to communicate with at least one of the end nodes and/or a network controller to obtain at least one resource identifier, a respective resource identifier identifying a respective resource in the chain for enabling the obtaining of the performance data of the respective resource.

7. The processor system as claimed in claim 6, wherein the chain comprises multiple parallel paths, and
the processor is further arranged to identify multiple resources as used by the multiple paths.

8. The processor system as claimed in claim 1, wherein the end node is arranged to exchange with the processor system requirements for providing forecast data; and
the processor is further arranged to exchange the requirements with the end node and to provide the forecast data according to the requirements.

9. The processor system as claimed in claim 1, the network further comprising a further processor system for monitoring traffic in the network, the further processor system being arranged to determine further forecast data representing a throughput forecast for a respective part of the chain based on respective performance data, the respective part of the chain being located in a further network domain different from a network domain where the end node is located,
wherein the processor is further arranged to communicate with the further processor system and to determine the forecast data using the further forecast data.

10. The processor system as claimed in claim 1,
wherein the network resource is arranged to generate the performance data comprising particular data, the particular data being at least one of:
a bitrate margin representing how close an actual traffic bitrate approaches a maximum achievable bitrate through a link or node,
a noise level on a link,
a noise margin representing how close an actual noise level approaches a maximum allowed noise level on a link,
amount of errors in a preceding period,
amount of retransmissions to recover from errors;
amount of bit swaps performed in correcting errors,
bit loading per carrier,
signal-to-noise-ratio (SNR) margin per carrier,
seamless rate adaptation (SRA) steps performed,
forward error correction data, including CRC actions, Code Violations,
number of retransmissions in a predetermined interval,
buffer-fill of retransmission buffer,
parameters of a crosstalk matrix of a vectoring system for identifying worst-case disturbers,
number of idle symbols representing unused bitrate, or
attainable bitrate provided by the modem.

11. An end node device arranged for adapting data traffic in a network, the network comprising network resources including nodes and links connecting the nodes, and the network being configurable for transferring data via a chain of network resources enabling application data traffic between the end node device and a further end node;
wherein at least one of the network resources in the chain is arranged to generate performance data representing a performance level of the data traffic at the network resource, and to exchange the performance data via the network;
wherein the processor system is arranged to
obtain the performance data,
determine forecast data representing a throughput forecast for the chain based on the performance data, and
communicate with the end node device to provide the forecast data; and
wherein the end node device comprises
a network interface for exchanging data via the network, and
a processor arranged to
execute at least one service application that establishes application data traffic via the chain,
communicate with the processor system to obtain the forecast data, and
adapt the application data traffic based on the forecast data.

12. The end node device as claimed in claim 11, wherein the end node device comprises a processor system comprising:
a communication interface for exchanging data via the network and
a processor arranged to
obtain the performance data,
determine the forecast data representing a throughput forecast for the chain based on the performance data, and
communicate with the end node to provide the forecast data.

13. A network resource for enabling data traffic in a network, the network comprising network resources including nodes and links connecting the nodes, and the network being configurable for transferring data via a chain of network resources enabling application data traffic between a first end node and a second end node, and the network resource to be part of the chain;
wherein at least one end node of the end nodes is arranged to
execute a service application that establishes application data traffic via the chain,
communicate with a processor system in the network to obtain forecast data, and
adapt the application data traffic based on the forecast data;
wherein the processor system is arranged to
obtain performance data from the network resource,
determine the forecast data representing a throughput forecast for the chain based on the performance data, and
communicate with the end node to provide the forecast data;
the network resource comprising
a resource network interface for exchanging the performance data via the network, and
a resource processor arranged
to receive performance criteria,
to generate the performance data representing a performance level of the data traffic at the network resource with respect to the performance criteria, and
to provide the performance data via the network to the processor system.

14. A processing method for monitoring data traffic in a network, the network comprising network resources including nodes and links connecting the nodes, and the network being configurable for transferring data via a chain of network resources enabling application data traffic between a first end node and a second end node;
wherein at least one of the network resources in the chain is arranged to generate performance data representing a performance level of the data traffic at the network resource, and to exchange the performance data via the network;
wherein at least one end node of the end nodes is arranged to
execute a service application that establishes application data traffic via the chain,
communicate with the processor system to obtain forecast data, and
adapt the application data traffic based on the forecast data; and
wherein the processing method comprises:
obtaining the performance data;
determining the forecast data representing a throughput forecast for the chain based on the performance data; and
communicating with the end node to provide the forecast data.

15. A service application method for adapting data traffic in a network, the network comprising network resources including nodes and links connecting the nodes, and the network being configurable for transferring data via a chain of network resources enabling application data traffic between a first end node and a second end node;
wherein at least one of the network resources in the chain is arranged to generate performance data representing a performance level of the data traffic at the network resource;
wherein at least one end node of said end nodes is arranged to execute the service application method;
wherein the processor system is arranged to
obtain the performance data,
determine forecast data representing a throughput forecast for the chain based on the performance data, and
communicate with the end node to provide the forecast data; and
wherein the service application method comprises:
establishing application data traffic via the chain;
communicating with the processor system to obtain the forecast data; and
adapting the application data traffic based on the forecast data.

16. The service application method as claimed in claim 15, wherein adapting the application data traffic comprises a particular operation, the particular operation being at least one of:
decreasing the application data traffic upon obtaining the forecast data indicative of a risk of data loss and/or transmission delay, or
increasing the application data traffic upon obtaining the forecast data indicative of low risk of data loss and/or transmission delay or the forecast data comprising a risk indicator representing a low risk level.

17. A non-transitory computer-readable medium having stored thereon instructions for a processing method for monitoring data traffic in a network, the network comprising network resources including nodes and links connecting the nodes, and the network being configurable for transferring data via a chain of network resources enabling application data traffic between a first end node and a second end node;
wherein at least one of the network resources in the chain is arranged to generate performance data representing a performance level of the data traffic at the network resource, and to exchange the performance data via the network;
wherein at least one end node of the end nodes is arranged to
execute a service application that establishes application data traffic via the chain,
communicate with the processor system to obtain forecast data, and
adapt the application data traffic based on the forecast data; and
wherein the instructions, when executed by one or more processors, cause the one or more processors to carry out operations including:
obtaining the performance data;
determining the forecast data representing a throughput forecast for the chain based on the performance data; and
communicating with the end node to provide the forecast data.

18. A non-transitory computer-readable medium having stored thereon instructions for a service application method for adapting data traffic in a network, the network comprising network resources including nodes and links connecting the nodes, and the network being configurable for transferring data via a chain of network resources enabling application data traffic between a first end node and a second end node;
wherein at least one of the network resources in the chain is arranged to generate performance data representing a performance level of the data traffic at the network resource;
wherein at least one end node of said end nodes is arranged to execute the service application method;
wherein the processor system is arranged to
obtain the performance data,
determine forecast data representing a throughput forecast for the chain based on the performance data, and
communicate with the end node to provide the forecast data; and
wherein the instructions, when executed by one or more processors, cause the one or more processors to carry out operations including:
establishing application data traffic via the chain;
communicating with the processor system to obtain the forecast data; and
adapting the application data traffic based on the forecast data.
